(19) United States
(12) Patent Application Publication
(10) Pub. No.: US 2023/0357081 A1
(43) Pub. Date: Nov. 9, 2023

(54) Non-Combustible Cement Board

(71) Applicant: PermaBASE Building Products, LLC, Charlotte, NC (US)

(72) Inventor: Marie-Andrée Mathieu, Bromont (CA)

(21) Appl. No.: 18/313,481

(22) Filed: May 8, 2023

Related U.S. Application Data
(60) Provisional application No. 63/339,565, filed on May 9, 2022.

(51) Int. Cl. C04B 16/08; C04B 14/10; C04B 14/18; C04B 20/00

(52) U.S. Cl. CPC C04B 16/08; C04B 14/108; C04B 14/185; C04B 20/004; C04B 2201/50; C04B 2201/20

(57) ABSTRACT

In the present disclosure, a cement board is disclosed. The cement board comprises a cement core having a first surface and a second surface opposite the first surface. The cement core comprises a binder, a lightweight aggregate, and a combustible additive, wherein the combustible additive is present in an amount of greater than 0 wt. % to less than 0.5 wt. % based on the weight of the cement core. The cement board passes CAN/ULC-S114:2018 and/or ASTM E136-19a.

### CROSS-REFERENCE TO RELATED APPLICATION

The present application claims filing benefit of U.S. Provisional Patent Application No. 63/339,565 having a filing date of May 9, 2022, which is hereby incorporated by reference in its entirety.

### BACKGROUND

Cement boards are typically utilized in the construction industry for various applications. Commonly used cement boards may have to satisfy certain requirements regarding non-combustibility. Certain commercial boards use combustible materials in their formulation, preventing them from being qualified as non-combustible. Certain commercial boards use additives incorporated within the board in order to satisfy the non-combustibility test. However, these particular additives may not be as suitable due to their weight, density, absorption characteristics, etc. In addition, certain additives may not allow for the cement board to have the desired mechanical properties.

As a result, there is a need to provide an improved cement board that is qualified as non-combustible even in the presence of combustible materials in its formulation.

### SUMMARY OF THE INVENTION

In accordance with one embodiment of the present invention, a cement board is disclosed. The cement board comprises a cement core having a first surface and a second surface opposite the first surface. The cement core comprises a binder, a lightweight aggregate, and a combustible additive, wherein the combustible additive is present in an amount of greater than 0 wt. % to less than 0.5 wt. % based on the weight of the cement core. The cement board passes CAN/ULC-S114:2018.

In accordance with another embodiment of the present invention, a cement board is disclosed. The cement board comprises a cement core having a first surface and a second surface opposite the first surface. The cement core comprises a binder, a lightweight aggregate, and a combustible additive, wherein the combustible additive is present in an amount of greater than 0 wt. % to less than 0.5 wt. % based on the weight of the cement core. The cement board passes ASTM E136-19a.

### DETAILED DESCRIPTION

Reference now will be made in detail to embodiments, one or more examples of which are illustrated in the drawings. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a cement board. For instance, the cement board includes certain additives wherein the board is still deemed non-combustible. In particular, these additives may generally be considered combustible additives. Yet, even with the incorporation of such additives, the present inventor has discovered that the cement board as disclosed herein may yet still be considered non-combustible. For instance, the cement board may pass CAN/ULC-S114:2018 and/or ASTM E136-19a.

In this regard, the cement board as disclosed herein can satisfy CAN/ULC-S114:2018. For instance, in accordance with such test, the mean of the maximum temperature rise for the specimens of the sample during the test shall not exceed 36° C. In one embodiment, the mean of the maximum temperature rise may not exceed 36° C., such as not exceed 35° C., such as not exceed 34° C., such as not exceed 33° C., such as not exceed 32° C., such as not exceed 31° C., such as not exceed 30° C. for the cement board as disclosed herein.

In addition, there should be no flaming of any of the specimens during the last 14.5 minutes of the test. In this regard, there may be no flaming for the last 14.5 minutes, such as the last 14.6 minutes, such as the last 14.7 minutes, such as the last 14.8 minutes, such as the last 14.9 minutes, such as the last 15 minutes for the cement board as disclosed herein.

Also, the maximum loss of any of the specimens during the test may not exceed 20%. In this regard, the maximum loss may be 20% or less, such as 19% or less, such as 18% or less, such as 17% or less, such as 16% or less, such as 15% or less, such as 14% or less, such as 13% or less, such as 12% or less, such as 11% or less, such as 10% or less for the cement board as disclosed herein. In addition, the maximum loss may be 0% or more, such as 1% or more, such as 2% or more, such as 3% or more, such as 4% or more, such as 5% or more, such as 6% or more, such as 7% or more, such as 8% or more, such as 9% or more for the cement board as disclosed herein.

Alternatively, the maximum loss of any of the specimens during the test shall not exceed 22% wherein the indicating thermocouple shall not rise above the stabilized furnace temperature at any time during the test and there is no flaming from the specimens during any time of the test. In this regard, when characterizing the maximum loss under the aforementioned standard, the maximum loss may be 22% or less, such as 21% or less, such as 20% or less, such as 19% or less, such as 18% or less, such as 17% or less, such as 16% or less, such as 15% or less, such as 14% or less, such as 13% or less, such as 12% or less, such as 11% or less, such as 10% or less for the cement board as disclosed herein. In addition, the maximum loss may be 0% or more, such as 1% or more, such as 2% or more, such as 3% or more, such as 4% or more, such as 5% or more, such as 6% or more, such as 7% or more, such as 8% or more, such as 9% or more for the cement board as disclosed herein.

In addition to the above, the cement board as disclosed herein may satisfy ASTM E136-19a. For instance, in accordance with such test, the average weight loss of the specimens may be 50% or less, such as 57% or less, such as 55% or less, such as 52% or less, such as 50% or less, such as 47% or less, such as 45% or less, such as 42% or less, such as 40% or less, such as 35% or less, such as 30% or less, such as 25% or less, such as 20% or less, such as 15% or less. The average weight loss may be more than 0%, such as 1% or more, such as 2% or more, such as 3% or more, such as 5% or more, such as 10% or more, such as 15% or more, such as 20% or more, such as 25% or more, such as 28% or more, such as 30% or more, such as 33% or more, such as 35% or more.

Furthermore, the recorded temperatures on the surface may not rise more than 30° C., such as not more than 28° C., such as not more than 26° C., such as not more than 24° C., such as not more than 22° C., such as not more than 20° C., such as not more than 18° C., such as not more than 16° C., such as not more than 14° C., such as not more than 12° C., such as not more than 10° C.

Also, the recorded temperatures on the interior may not rise more than 30° C., such as not more than 28° C., such as not more than 26° C., such as not more than 24° C., such as not more than 22° C., such as not more than 20° C., such as not more than 18° C., such as not more than 16° C., such as not more than 14° C., such as not more than 12° C., such as not more than 10° C.

As indicated above, in general, the present invention is directed to a cement board. The cement board includes a core, also referred to as a cement core. In general, the composition of the core is not necessarily limited and may be any core generally known in the art. Regardless, the core is typically made from a slurry including at least water and a binder.

The cement core also includes a binder. In general, the binder includes a material which is able to set on hydration. Such materials may also be generally referred to as a hydraulic cement. The present invention is not necessarily limited and may include binders generally known in the art. For instance, these may include, but are not limited to, a cement, a pozzolan material, gypsum, or a mixture thereof. In particular, the binder may include a cement.

The cement may include any cement as generally known in the art. For instance, the cement may include, but is not limited to, Portland cement, magnesia cement, alumina cement (e.g., calcium aluminate cement), calcium sulphoaluminate cement, or a mixture thereof. In one embodiment, the cement may include at least Portland cement. In another embodiment, the cement may include at least alumina cement. In one embodiment, the binder includes at least two, such as at least three the cements. For example, in one embodiment, the binder may include at least Portland cement and an alumina cement.

When the cement board includes Portland cement and alumina cement, they may be present within a certain weight ratio. For instance, the weight ratio of Portland cement to alumina cement may be 2 or more, such as 3 or more, such as 4 or more, such as 5 or more, such as 6 or more, such as 7 or more, such as 8 or more, such as 9 or more. The weight ratio may be 50 or less, such as 40 or less, such as 30 or less, such as 25 or less, such as 20 or less, such as 18 or less, such as 16 or less, such as 14 or less, such as 12 or less, such as 10 or less, such as 9 or less, such as 8 or less, such as 7 or less, such as 6 or less.

The pozzolan material may include any pozzolan material as generally known in the art. For instance, the pozzolan material may include, but is not limited to, fly ash, blast furnace slag, diatomaceous earth, metakaolin, silica fume, microsilica, or a mixture thereof. In one embodiment, the pozzolan material may include fly ash. In another embodiment, the pozzolan material may include blast furnace slag. In a further embodiment, the pozzolan material may include metakaolin. In another further embodiment, the pozzolan material may include silica fume. In another further embodiment, the pozzolan material may include diatomaceous earth. In an even further embodiment, the pozzolan material may include microsilica. In one embodiment, the binder includes at least two, such as at least three pozzolan materials.

In general, the binder may also include gypsum. When in the core, it may be present as uncalcined gypsum (i.e., calcium sulfate dihydrate). When added to the slurry, it may be added as calcined gypsum (i.e., calcium sulfate hemihydrate). Regardless, when utilized, it may be utilized in generally lower amounts. For example, the gypsum may be present in the core in an amount of 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.5 wt. % or less based on the weight of the core. In one embodiment, the gypsum may be present in an amount of 0 wt. % based on the weight of the core. In addition, it should be understood that the aforementioned weight percentages may also apply to the amount of the gypsum based on the weight of the cement board. Further, it should be understood that the aforementioned weight percentages may also apply to the amount of the gypsum based on the weight of the slurry when discussed in the context of the cement slurry in making the cement board.

In general, the cement(s) may be present in the core in an amount of 1 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The cement(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less, such as 15 wt. % or less based on the weight of the core. In addition, it should be understood that the aforementioned weight percentages may also apply to the amount of the cement(s) based on the weight of the cement board. Further, it should be understood that the aforementioned weight percentages may also apply to the amount of the cement(s) based on the weight of the slurry when discussed in the context of the cement slurry in making the cement board. In addition, the aforementioned percentages may also apply to a particular species of cement.

In general, the pozzolan material(s) may be present in the core in an amount of 0 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The pozzolan material(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less based on the weight of the core. In addition, it should be understood that the aforementioned weight percentages may also apply to the amount of the pozzolan material(s) based on the weight of the cement board. Further, it should be understood that the aforementioned weight percentages may also apply to the amount of the pozzolan material(s) based on the weight of the slurry when discussed in the context of the cement slurry in making the cement board. In addition, the aforementioned percentages may also apply to a particular species of pozzolan material.

In other embodiments, the cement core may include a relatively low amount of pozzolan material(s). For instance, the pozzolan material(s) may be present in an amount of 20 wt. % or less, such as 18 wt. % or less, such as 16 wt. % or less, such as 18 wt. % or less, such as 14 wt. % or less, such as 12 wt. % or less, such as 10 wt. % or less, such as 8 wt. % or less, such as 6 wt. % or less, such as 4 wt. % or less, such as 2 wt. % or less, such as 1 wt. % or less, such as 0.5 wt. % or less based on the weight of the core. The pozzolan material(s) may be present in an amount of 0 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more based on the weight of the core. In addition, it should be understood that the aforementioned weight percentages may also apply to the amount of the pozzolan material(s) based on the weight of the cement board. Further, it should be understood that the aforementioned weight percentages may also apply to the amount of the pozzolan material(s) based on the weight of the slurry when discussed in the context of the cement slurry in making the cement board.

In one particular embodiment, the fly ash may be present in a certain amount. For instance, the fly ash may be present in an amount of 20 wt. % or less, such as 18 wt. % or less, such as 16 wt. % or less, such as 18 wt. % or less, such as 14 wt. % or less, such as 12 wt. % or less, such as 10 wt. % or less, such as 8 wt. % or less, such as 6 wt. % or less, such as 4 wt. % or less, such as 2 wt. % or less, such as 1 wt. % or less, such as 0.5 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as about 0 wt. % based on the weight of the core. The fly ash may be present in an amount of 0 wt. % or more. For example, if present, the fly ash may be present in an amount of 0.1 wt. % or more, such as 0.2 wt. % or more, such as 0.5 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more based on the weight of the core. In addition, it should be understood that the aforementioned weight percentages may also apply to the amount of the fly ash based on the weight of the cement board. Further, it should be understood that the aforementioned weight percentages may also apply to the amount of the fly ash based on the weight of the slurry when discussed in the context of the cement slurry in making the cement board.

In one embodiment, the binder may include a combination of a cement and a pozzolan material. For instance, the weight ratio of the total weight of the pozzolan materials to the total weight of the cement may be 0 or more, such as 0.01 or more, such as 0.1 or more, such as 0.1 or more, such as 0.2 or more, such as 0.5 or more, such as 0.8 or more, such as 1 or more, such as 1.5 or more, such as 2 or more, such as 2.5 or more, such as 3 or more, such as 4 or more, such as 5 or more. The weight ratio may be 10 or less, such as 8 or less, such as 6 or less, such as 5 or less, such as 4 or less, such as 3 or less, such as 2.5 or less, such as 2 or less, such as 1.5 or less, such as 1 or less, such as 0.5 or less, such as 0.4 or less.

In particular, the binder may include a combination of a cement and a fly ash. For instance, the weight ratio of the total weight of the fly ash to the total weight of the cement may be 0 or more, such as 0.01 or more, such as 0.1 or more, such as 0.1 or more, such as 0.2 or more, such as 0.5 or more, such as 0.8 or more, such as 1 or more. The weight ratio may be 1 or less, such as 0.5 or less, such as 0.4 or less.

In general, the binder(s) may be present in the core in an amount of 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more, such as 55 wt. % or more, such as 60 wt. % or more, such as 65 wt. % or more based on the weight of the core. The binder(s) may be present in the core in an amount of less than 100 wt. %, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less based on the weight of the core. In addition, it should be understood that the aforementioned weight percentages may also apply to the amount of the binder(s) based on the weight of the cement board. Further, it should be understood that the aforementioned weight percentages may also apply to the amount of the binder(s) based on the weight of the slurry when discussed in the context of the cement slurry in making the cement board.

The cement core may also include aggregates. For instance, the aggregates may include normal weight aggregates, lightweight aggregates, or a mixture thereof. In one embodiment, the cement core includes normal weight aggregates. In a further embodiment, the cement core includes lightweight aggregates. In an even further embodiment, the cement core includes a mixture of normal weight aggregates and lightweight aggregates. However, in addition to the above, it should be understood that the aggregates may also include heavy weight aggregates.

In general, normal weight aggregate may have a density of 1,100 kg/m3 or more, such as 1,300 kg/m3 or more, such as 1,500 kg/m3 or more to 2,100 kg/m3 or less, such as 2,000 kg/m3 or less, such as 1,800 kg/m3 or less, such as 1,600 kg/m3 or less. Meanwhile, lightweight aggregate may have a density of less than 1,100 kg/m3, such as 1,000 kg/m3 or less, such as 900 kg/m3 or less, such as 800 kg/m3 or less, such as 700 kg/m3 or less, such as 600 kg/m3 or less. In addition, heavy weight aggregate may have a density of greater than 2,100 kg/m3.

In general, the normal weight aggregate may include any normal weight aggregate as generally known in the art. For instance, the normal weight aggregate may include, but is not limited to, sand, stone (e.g., crushed stone), limestone, shale, clay, recycled concrete, granite or other minerals, and the like, or a mixture thereof. In one embodiment, the normal weight aggregate includes sand (e.g., mortar grade sand). In another embodiment, the normal weight aggregate includes stone. In a further embodiment, the normal weight aggregate includes limestone. In an even further embodiment, the normal weight aggregate includes granite. In one embodiment, the normal weight aggregate includes at least two, such as at least three, such as at least four normal weight aggregates.

In general, the lightweight aggregate may include a material having a cellular or internal porous microstructures. For instance, the lightweight aggregate may include, but is not limited to, expanded shale, clay (e.g., expanded clay), foamed slag, sintered fly ash, vermiculite (e.g., expanded vermiculite), perlite (e.g., expanded perlite), pumice (e.g., expanded pumice), expanded glass (e.g., expanded closed-cell glass beads), hollow spheres (e.g., ceramic hollow spheres, glass hollow spheres, plastic hollow spheres, geopolymer hollow spheres, fly ash hollow spheres, silicate hollow spheres, or a mixture there), and the like, or a mixture thereof. In one embodiment, the lightweight aggregate includes perlite, such as expanded perlite. In another embodiment, the lightweight aggregate includes expanded shale. In one embodiment, the lightweight aggregate includes at least two, such as at least three, such as at least four lightweight aggregates. As an example, the lightweight aggregate includes a combination of perlite, such as expanded perlite, and/or expanded shale in one embodiment.

As indicated above, in one embodiment, the lightweight aggregate includes perlite. For instance, the perlite may be an expanded perlite. The perlite may be a closed-cell perlite, such as a closed-cell expanded perlite. In general, the perlite may have a general spherical structure.

The perlite may be non-hydrophobic or hydrophobic. For instance, in one embodiment, the perlite may be non-hydrophobic. In another embodiment, the perlite may be hydrophobic. For instance, the perlite may be treated, in particular to render the perlite hydrophobic. The treatment may be a coating on the surface of the perlite. For example, the coating may be a silicone, a silane, fatty acid derivative, or a mixture thereof. The coating may be formed on the perlite using various means in the art, such as spraying, dipping, misting, etc. In addition, the material be provided as a solution, such as an emulsion, in order to form the coating. Without intending to be limited by theory, the coating may prevent or minimize the ability of the perlite to absorb water.

For instance, in one embodiment, the coating may be a silicone coating. The silicone coating may be a siloxane polymer. The siloxane polymer may be a polyalkylsiloxane, in particular a polydialkylsiloxane, a polyarylsiloxane, in particular a polydiarylsiloxane, or a mixture thereof. In general, the alkyl may be a methyl, an ethyl, a propyl, a butyl, a pentyl, a hexyl, a heptyl, an octyl, or a nonyl group. In this regard, the alkyl may be a C₁-C₉ alkyl group, a C₁-C₅ alkyl group, a C₁-C₃ alkyl group, a C₁-C₂ alkyl group. In this regard, the siloxane polymer may be a polydimethylsiloxane. In addition, other siloxane polymers may include, but are not limited to, polydiethylsiloxane, polydipropylsiloxane, polydibutylsiloxane, polymethylethylsiloxane, polydiphenylsiloxane, etc.

In one embodiment, the coating may include a fatty acid derivative. Suitable fatty acids typically have a backbone carbon chain of from about 12 to about 60 carbon atoms. For example, the chain may have 12 or more, such as 14 or more, such as 16 or more, such as 18 or more, such as 20 or more carbon atoms. The chain may have 60 or less, such as 50 or less, such as 40 or less, such as 30 or less, such as 26 or less, such as 24 or less, such as 22 or less, such as 20 or less carbon atoms. The fatty acid may include, but is not limited to, myristic acid, palmitic acid, stearic acid, arachidonic acid, montanic acid, octadecanoic acid, parinaric acid, etc. The fatty acid may be saturated in one embodiment. In another embodiment, the fatty acid may be unsaturated.

Suitable derivatives include fatty acid esters, fatty alcohol esters, wax esters, fatty acid salts, fatty acid amides, etc. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids. These salts may include an alkali metal, an alkaline earth metal, a transition metal, etc. In particular, these metals may include, but are not limited to calcium, zinc, magnesium, aluminum, etc. For example, in one embodiment, the fatty acid derivative may include a stearate, such as calcium stearate, zinc stearate, magnesium stearate, or a mixture thereof.

In one embodiment, the coating may include a silane, such as an organosilane. The organosilane may have the structure X—R—Si(OR′)₃ wherein X can be a non-hydrolysable organic moiety comprising an epoxy, amino, vinyl methacryloxy, or sulfido moiety; R can be an arylene or an alkylene; and OR′ can be a moiety that can be hydrolysable.

As indicated above, X can be a non-hydrolysable organic moiety comprising an epoxy, amino, vinyl methacryloxy, or sulfido moiety. In one embodiment, X may be a non-hydrolysable organic moiety comprising an epoxy. In another embodiment, X may be a non-hydrolysable organic moiety comprising an amino.

As indicated above, R can be an arylene or an alkylene chain. For instance, in one embodiment, R may be arylene, such as a C₅-C₁₀ arylene, such as a C₅-C₈ arylene, such as a C₅-C₈ arylene, such as a C₅ arylene or a C₆ arylene. In another embodiment, R may be an alkylene. For example, the alkylene may be a C₁-C₆ alkylene, such as a C₁-C₄ alkylene, such as a C₁-C₃ alkylene, such as a C₁-C₂ alkylene or a C₂-C₃ alkylene. In one embodiment, R may be ethylene. In another embodiment, R may be propylene.

As indicated above, OR′ can be a moiety that can be hydrolysable. For instance, the moiety may be an alkoxy group (e.g., methoxy, ethoxy, isoproxy, butoxy) or an acetoxy group. In one embodiment, the moiety may be an alkoxy group. For example, in one embodiment, the moiety may be methoxy.

The organosilane can be bifunctional, wherein each molecule exhibits at least two reactive binding sites. The organosilane may include, but is not limited to, an epoxy silane (e.g., γ-glycidyloxypropyltrimethoxysilane), a glycidyl ether alkoxysilane, a glycidylalkyl alkoxysilane, an amino silane, an alkoxysilane, an aminoalkoxysilane, an alkyl silane, a vinyl silane, an acryloyl or methacryloyl-functional alkoxysilane, a sulfane or polysulfane-functional alkoxysilane, a mercapto-functional alkoxysilane, or a mixture thereof. In one embodiment, the organosilane may be an epoxy silane. In another embodiment, the organosilane may be an alkoxysilane, such as a halogen (e.g., chloro-, fluoro-) functional alkoxysilane.

For example, the organosilane may include, but is not limited to, γ-glycidyloxypropyltrimethoxysilane; N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris(beta-methoxyethoxy) silane; vinyl tri ethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltrichlorosilane; vinyltris(beta-methoxyethoxy)silane; vinyltrimethoxysilane; r-metacryloxypropyltrimethoxysilane; beta-(3,4 epoxycyclohexyl)-ethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-phenyl-r-aminopropyltrimethoxysilane; r-mercaptopropyltrimethoxysilane; r-chloropropyltrimethoxysilane; hydrogentrimethoxysilane, hydrogentriethoxysilane, tetramethoxysilane, tetraethoxysilane, methyltrimethoxysilane, methyltriethoxysilane, methyltripropoxysilane, ethyltrimethoxysilane, ethyltriethoxysilane, n-propyltrimethoxysilane, isopropyltrimethoxysilane, n-propyltriethoxysilane, isopropyltriethoxysilane, n-butyltrimethoxysilane, isobutyltrimethoxysilane, n-butyltriethoxysilane, isobutyltriethoxysilane, n-pentyltrimethoxysilane, isopentyltrimethoxysilane, n-pentyltriethoxysilane, isopentyltriethoxysilane, n-hexyltrimethoxysilane, isohexyltrimethoxysilane, n-octyltrimethoxysilane, isooctyltrimethoxysilane, n-octyltriethoxysilane, isooctyltriethoxysilane, hexadecyltrimethoxysilane, hexadecyltriethoxysilane, octadecyltrimethoxysilane, octadecyltriethoxysilane, dimethyldimethoxysilane, dimethyldiethoxysilane, n-butylmethyldimethoxysilane, isobutylmethyldimethoxysilane, n-butylmethyldiethoxysilane, isobutylmethyldiethoxysilane, cyclohexylmethyldimethoxysilane, diisopropyldimethoxysilane, diisobutyldimethoxysilane, isobutylisopropyldimethoxysilane, vinyltrimethoxysilane, vinyltriethoxysilane, vinylmethyldialkoxysilane, vinyltris(2-methoxyethoxysilane), 1-aminomethyltrimethoxysilane, 1-aminomethyltriethoxysilane, 2-aminoethyltrimethoxysilane, 2-aminoethyltriethoxysilane, 3-aminopropyltrimethoxysilane, 3-aminopropyltriethoxysilane, 3-aminoisobutyltrimethoxysilane, 3-aminoisobutyltriethoxysilane, N-(n-butyl)-3-aminopropyltrimethoxysilane, 3-aminopropylmethyldiethoxysilane, 3-ureidopropyltrimethoxysilane, 3-ureidopropyltriethoxysilane, N-aminoethyl-3-aminopropyltrimethoxysilane, N-aminoethyl-3-aminopropyltriethoxysilane, triamino-functional propyltrimethoxysilane, 3-(4,5-dihydroimidazolyl)propyltriethoxysilane, 3-glycidyloxypropyltrimethoxysilane, 3-glycidyloxypropyltriethoxysilane, tridecafluorooctyltriethoxysilane, tridecafluorooctyltrimethoxysilane, 3-chloropropyltriethoxysilane, acryloyloxypropyltrimethoxysilane, acryloyloxypropyltriethoxysilane, 3-methacryloyloxypropyltrimethoxysilane, 3-methacryloyloxypropyltriethoxysi lane, 3-methacryloyloxyisobutyltrimethoxysilane, 3-methacryloyloxyisobutyltriethoxysilane, 3-methacryloyloxy-2-methylpropyltrimethoxysilane, 3-methacryloyloxy-2-methylpropyltriethoxysilane, 3-mercaptopropyltrimethoxysilane, 3-mercaptopropyltriethoxysilane, (triethoxysilylpropyl)tetrasulfane, bis(trimethoxysilylpropyl)tetrasulfane, bis(triethoxysilylpropyl)disulfane, bis(trimethoxysilylpropyl)disulfane, bis(triethoxysilylpropyl)sulfane, bis(trimethoxysilylpropyl)sulfane, bis(triethoxysilylpropyl)pentasulfane, bis(trimethoxysilylpropyl)pentasulfane, or a mixture thereof.

As indicated by the structure above, the organosilane may differ from the siloxane in that the organosilane may be a distinct compound, rather than an oligomer or polymer, whether a thermoset or thermoplastic. Meanwhile, the siloxane may be an oligomer or polymeric type material, in particular a thermoplastic or thermoset type material.

The coating may be present in an amount of 0.001 wt. % or more, such as 0.005 wt. % or more, such as 0.01 wt. % or more, such as 0.03 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more based on the total weight of the perlite with the coating. The coating may be present in an amount of 20 wt. % or less, such as 18 wt. % or less, such as 15 wt. % or less, such as 12 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the perlite with the coating. In a further embodiment, such aforementioned weight percentages may be for the coating based on the weight of the uncoated perlite.

The perlite may have a loose bulk density of 50 kg/m3 or more, such as 60 kg/m3 or more such as 70 kg/m3 or more, such as 80 kg/m3 or more, such as 90 kg/m3 or more, such as 100 kg/m3 or more, such as 110 kg/m3 or more, such as 120 kg/m3 or more, such as 130 kg/m3 or more, such as 140 kg/m3 or more. The perlite may have a loose bulk density of 200 kg/m3 or less, such as 190 kg/m3 or less, such as 180 kg/m3 or less, such as 170 kg/m3 or less, such as 160 kg/m3 or less, such as 150 kg/m3 or less, such as 140 kg/m3 or less, such as 130 kg/m3 or less, such as 120 kg/m3 or less, such as 110 kg/m3 or less, such as 100 kg/m3 or less.

The perlite may have a particular average particle size of 100 microns or more, such as 110 microns or more, such as 120 microns or more, such as 130 microns or more, such as 150 microns or more, such as 180 microns or more, such as 200 microns or more, such as 230 microns or more, such as 250 microns or more, such as 280 microns or more, such as 300 microns or more, such as 320 microns or more, such as 350 microns or more. The average particle size may be 600 microns or less, such as 580 microns or less, such as 550 microns or less, such as 530 microns or less, such as 500 microns or less, such as 470 microns or less, such as 450 microns or less, such as 430 microns or less, such as 410 microns or less, such as 400 microns or less, such as 390 microns or less, such as 370 microns or less, such as 350 microns or less.

The perlite may have a d98 of 150 microns or more, such as 160 microns or more, such as 170 microns or more, such as 180 microns or more, such as 190 microns or more, such as 200 microns or more, such as 210 microns or more, such as 230 microns or more, such as 250 microns or more, such as 270 microns or more, such as 290 microns or more, such as 300 microns or more, such as 320 microns or more, such as 340 microns or more, such as 350 microns or more. The perlite may have a d98 of 500 microns or less, such as 450 microns or less, such as 420 microns or less, such as 400 microns or less, such as 380 microns or less, such as 350 microns or less, such as 320 microns or less, such as 300 microns or less, such as 270 microns or less, such as 250 microns or less, such as 220 microns or less, such as 210 microns or less, such as 200 microns or less.

As indicated above, in one embodiment, the lightweight aggregate includes expanded shale. The expanded shale may have a particular particle size. For instance, the average particle size may be 100 mm or less, such as 9 mm or less, such as 8 mm or less, such as 7 mm or less, such as 6 mm or less, such as 5.5 mm or less, such as 5 mm or less, such as 4.5 mm or less, such as 4 mm or less, such as 3.5 mm or less, such as 3.2 mm or less, such as 3 mm or less, such as 2.8 mm or less, such as 2.5 mm or less, such as 2.2 mm or less, such as 2 mm or less, such as 1.8 mm or less, such as 1.6 mm or less, such as 1.4 mm or less, such as 1.2 mm or less, such as 1 mm or less, such as 0.9 mm or less, such as 0.8 mm or less, such as 0.7 mm or less, such as 0.6 mm or less, such as 0.5 mm or less, such as 0.4 mm or less. The average particle size may be 0.1 mm or more, such as 0.2 mm or more, such as 0.3 mm or more, such as 0.5 mm or more, such as 0.7 mm or more, such as 0.9 mm or more, such as 1 mm or more, such as 1.2 mm or more, such as 1.5 mm or more, such as 1.8 mm or more, such as 2 mm or more, such as 2.5 mm or more, such as 3 mm or more, such as 3.5 mm or more, such as 4 mm or more, such as 4.5 mm or more, such as 5 mm or more, such as 5.5 mm or more. In one embodiment, such aforementioned size may refer to the average longest dimension (e.g., diameter) of the expanded shale.

The expanded shale may also have a particular density. For instance, the density may be 75 pcf or less, such as 72 pcf or less, such as 70 pcf or less, such as 68 pcf or less, such as 66 pcf or less, such as 64 pcf or less, such as 62 pcf or less, such as 60 pcf or less, such as 58 pcf or less, such as 55 pcf or less, such as 53 pcf or less, such as 50 pcf or less, such as 47 pcf or less, such as 45 pcf or less, such as 42 pcf or less. The density may be 30 pcf or more, such as 33 pcf or more, such as 35 pcf or more, such as 38 pcf or more, such as 40 pcf or more, such as 43 pcf or more, such as 45 pcf or more, such as 48 pcf or more, such as 50 pcf or more, such as 53 pcf or more, such as 55 pcf or more, such as 58 pcf or more, such as 60 pcf or more.

In general, the aggregate(s) may be present in the core in an amount of 0.1 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 65 wt. % or more based on the weight of the core. The aggregate(s) may be present in the core in an amount of 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less based on the weight of the core. In addition, it should be understood that the aforementioned weight percentages may also apply to the amount of the aggregate(s) based on the weight of the cement board. Further, it should be understood that the aforementioned weight percentages may also apply to the amount of the aggregate(s) based on the weight of the slurry when discussed in the context of the cement slurry in making the cement board. In addition, the aforementioned percentages may also apply to a particular species of aggregate.

Furthermore, the normal weight aggregate(s) may be present in the core in an amount of 0.1 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 65 wt. % or more based on the weight of the core. The normal weight aggregate(s) may be present in the core in an amount of 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less based on the weight of the core. In addition, it should be understood that the aforementioned weight percentages may also apply to the amount of the normal weight aggregate(s) based on the weight of the cement board. Further, it should be understood that the aforementioned weight percentages may also apply to the amount of the normal weight aggregate(s) based on the weight of the slurry when discussed in the context of the cement slurry in making the cement board. In addition, the aforementioned percentages may also apply to a particular species of normal weight aggregate. For instance, the aforementioned weight percentages may apply to limestone in one embodiment. In another embodiment, the aforementioned weight percentages may apply to sand. In a further embodiment, the aforementioned weight percentages may apply to a combination of limestone and sand.

In addition, the lightweight aggregate(s) may be present in the core in an amount of 0.1 wt. % or more, such as 0.3 wt. % or more, such as 0.5 wt. % or more, such as 0.8 wt. % or more, such as 1 wt. % or more, such as 1.5 wt. % or more, such as 2 wt. % or more, such as 2.5 wt. % or more, such as 3 wt. % or more, such as 3.5 wt. % or more, such as 4 wt. % or more, such as 5 wt. % or more, such as 7 wt. % or more, such as 10 wt. % or more, such as 13 wt. % or more, such as 15 wt. % or more, such as 20 wt. % or more, such as 25 wt. % or more, such as 30 wt. % or more, such as 35 wt. % or more based on the weight of the core. The lightweight aggregate(s) may be present in the core in an amount of 50 wt. % or less, such as 45 wt. % or less, such as 40 wt. % or less, such as 35 wt. % or less, such as 30 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.6 wt. % or less, such as 0.4 wt. % or less, such as 0.3 wt. % or less based on the weight of the core. In addition, it should be understood that the aforementioned weight percentages may also apply to the amount of the lightweight aggregate(s) based on the weight of the cement board. Further, it should be understood that the aforementioned weight percentages may also apply to the amount of the lightweight aggregate(s) based on the weight of the slurry when discussed in the context of the cement slurry in making the cement board. In addition, the aforementioned percentages may also apply to a particular species of lightweight aggregate. For instance, the aforementioned weight percentages may apply to expanded shale in one embodiment. In another embodiment, the aforementioned weight percentages may apply to perlite. In a further embodiment, the aforementioned weight percentages may apply to a combination of expanded shale and perlite.

Furthermore, the aforementioned provides weight percentages for lightweight aggregates. However, in one embodiment, such percentages may be for lightweight aggregates not considered a combustible additive as defined herein.

Also, it should be understood that the aforementioned weight percentages may apply individually to the normal weight aggregates. Furthermore, it should be understood that the aforementioned weight percentages may apply individually to the lightweight aggregates. When both a normal weight aggregate and a lightweight aggregate are utilized, they may be present within a specific weight ratio. For instance, the weight ratio of the normal weight aggregate to the lightweight aggregate may be 0.01 or more, such as 0.05 or more, such as 0.1 or more, such as 0.2 or more, such as 0.3 or more, such as 0.5 or more, such as 1 or more, such as 3 or more, such as 5 or more, such as 8 or more, such as 10 or more, such as 11 or more, such as 12 or more, such as 13 or more, such as 15 or more. The weight ratio may be 100 or less, such as 90 or less, such as 80 or less, such as 70 or less, such as 60 or less, such as 50 or less, 40 or less, such as 30 or less, such as 25 or less, such as 20 or less, such as 18 or less, such as 15 or less, such as 13 or less, such as 10 or less, such as 8 or less, such as 6 or less, such as 4 or less, such as 2 or less, such as 1.5 or less, such as 1 or less, such as 0.8 or less, such as 0.6 or less, such as 0.5 or less, such as 0.4 or less, such as 0.3 or less, such as 0.2 or less. In one embodiment, such ratio may be based on all of the normal weight aggregates and lightweight aggregates.

As indicated herein, the cement board also includes a combustible additive. In general, a noncombustible additive may be one that passes the criteria in ASTM E136-19a (2022) when tested in accordance with either ASTM E136 or ASTM E2652. These materials may include those such as masonry, glass, steel, etc. The combustible additives as defined herein may be limited combustible materials or combustible materials. As an example, limited combustible materials may be those that produce a heat value less than 3,500 BTU/lb when tested in accordance with NFPA 259 and/or when tested in accordance with ASTM E2965 at an incident heat flux of 75 kW/m2 for 20 minutes, they meet the following conditions: a peak heat release rate doesn't exceed 150 kW/m2 for more than 10 seconds and the total heat released is less than 8 MJ/m2. In general, any combustible materials may be those not considered a noncombustible additive or a limited combustible material.

For instance, polystyrene (e.g., expanded polystyrene) may be considered a combustible additive. The polystyrene may include polystyrene beads, such as closed-cell polystyrene beads. Such polystyrene beads may be expanded polystyrene beads. The expanded polystyrene beads may have a particular size distribution. For instance, when taking into account all of the expanded beads, the average diameter of the expanded polystyrene beads may be 0.01 inches or more, such as 0.015 inches or more, such as 0.02 inches or more, such as 0.03 inches or more, such as 0.04 inches or more, such as 0.05 inches or more, such as 0.06 inches or more, such as 0.07 inches or more, such as 0.08 inches or more, such as 0.09 inches or more, such as 0.1 inches or more, such as 0.11 inches or more, such as 0.12 inches or more, such as 0.13 inches or more, such as 0.14 inches or more, such as 0.15 inches or more. The diameter may be 0.5 inches or less, such as 0.4 inches or less, such as 0.3 inches or less, such as 0.25 inches or less, such as 0.2 inches or less, such as 0.18 inches or less, such as 0.15 inches or less, such as 0.13 inches or less, such as 0.12 inches or less, such as 0.11 inches or less, such as 0.1 inches or less, such as 0.09 inches or less, such as 0.08 inches or less, such as 0.07 inches or less, such as 0.06 inches or less, such as 0.05 inches or less, such as 0.04 inches or less, such as 0.03 inches or less, such as 0.02 inches or less.

In one embodiment, the expanded polystyrene beads may have a unimodal size distribution wherein the average diameter is within the aforementioned range. In another embodiment, the expanded polystyrene beads may have a bimodal size distribution. For instance, a first set of expanded polystyrene beads may have an average diameter less than a second set of expanded polystyrene beads. The first set of expanded polystyrene beads may have an average diameter within the aforementioned range. Also, the second set of expanded polystyrene beads may also have an average diameter within the aforementioned range. Regardless, the first set has an average diameter less than the second set. Furthermore, the first set having an average diameter less than the second set may be present in an amount of 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more to less than 100 wt. %, such as 90 wt. % or less, such as 80 wt. % or less, such as 70 wt. % or less, such as 60 wt. % or less, such as 50 wt. % or less based on the total weight of the expanded polystyrene beads. In this regard, the balance may be occupied by the second set of expanded polystyrene beads.

The polystyrene beads and means for expanding are further described in U.S. Pat. No. 9,499,980, which is hereby incorporated by reference in its entirety.

The polystyrene may be utilized within a certain amount within the cement board as defined herein. In particular, the polystyrene is present in an amount of 1 wt. % or less, such as 0.8 wt. % or less, such as 0.6 wt. % or less, such as 0.5 wt. % or less, such as 0.45 wt. % or less, such as 0.4 wt. % or less, such as 0.35 wt. % or less, such as 0.3 wt. % or less based on the weight of the core. The polystyrene may be present in an amount of 0 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more based on the weight of the core. In addition, it should be understood that the aforementioned weight percentages may also apply to the amount of the polystyrene based on the weight of the cement board. Further, it should be understood that the aforementioned weight percentages may also apply to the amount of the polystyrene based on the weight of the slurry when discussed in the context of the cement slurry in making the cement board.

While the above may be utilized, in one embodiment, any additives considered a combustible additive may be used in a limited amount. In this regard, the combustible additives may be present in an amount of 1 wt. % or less, such as 0.8 wt. % or less, such as 0.6 wt. % or less, such as 0.5 wt. % or less, such as 0.45 wt. % or less, such as 0.44 wt. % or less, such as 0.4 wt. % or less, such as 0.35 wt. % or less, such as 0.3 wt. % or less based on the weight of the core. The combustible additives may be present in an amount of 0 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more based on the weight of the core. In addition, it should be understood that the aforementioned weight percentages may also apply to the amount of the combustible additives based on the weight of the cement board. Further, it should be understood that the aforementioned weight percentages may also apply to the amount of the combustible additives based on the weight of the slurry when discussed in the context of the cement slurry in making the cement board. In addition, in one embodiment, the aforementioned percentages may apply to the total amount of combustible additives. In another embodiment, the aforementioned percentages may apply to a particular species of combustible additives.

The cement core may also include a chemical set admixture. For instance, the chemical set admixture may be utilized to alter the hydration or properties of the slurry. For instance, such admixture may include a retarder, an accelerator, and the like, or a mixture thereof. In one embodiment, the admixture may include at least a retarder. In another embodiment, the admixture may include at least an accelerator.

In general, the chemical set admixture may include, but is not limited to, lithium salts (e.g., lithium carbonate), sodium tripolyphosphate, alkanolamines (e.g., triethanolamine), nitrites (e.g., calcium nitrite, sodium nitrite, etc.) calcium formate, sulfates (e.g., aluminum sulfate, sodium sulfate, calcium sulfate), sodium carbonate, calcium chloride, silicates (e.g., magnesium fluorosilicate, sodium silicate), calcium hydroxide, calcium-aluminate cement, boric acid, borax, formic acid, citric acid, sodium citrate, sodium gluconate, glucose, sucrose, fructose, or a mixture thereof. In one embodiment, the admixture may include a nitrite. In another embodiment, the admixture may include a sulfate. In a further embodiment, the admixture may include citric acid. In an even further embodiment, the admixture may include a sodium citrate. In one embodiment, the admixture includes at least two, such as at least three, such as at least four components.

In general, the chemical set admixture(s) may be present in the core in an amount of 0 wt. % or more, such as 0.0001 wt. % or more, such as 0.001 wt. % or more, such as 0.01 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The chemical set admixture(s) may be present in the core in an amount of 20 wt. % or less, such as 15 wt. % or less, such as 13 wt. % or less, such as 10 wt. % or less, such as 9 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less, such as 1 wt. % or less, such as 0.5 wt. % or less, such as 0.3 wt. % or less, such as 0.1 wt. % or less based on the weight of the core. In addition, it should be understood that the aforementioned weight percentages may also apply to the amount of the chemical set admixture(s) based on the weight of the cement board. Further, it should be understood that the aforementioned weight percentages may also apply to the amount of the chemical set admixture(s) based on the weight of the slurry when discussed in the context of the cement slurry in making the cement board. In addition, the aforementioned percentages may also apply to a particular species within the chemical set admixture.

The cement core may also include a rheological admixture that serves as a rheology modifier and may also possibly serve as a strength enhancer. For instance, the rheological admixture may be utilized to reduce the water usage or alter the rheology of the slurry.

In general, the rheological admixture may include, but is not limited to, sulfonates (e.g., melamine sulfonate, sodium naphthalene sulfonate, lignosulfonates, etc.), polycarboxylate ethers, cellulose polymer derivatives (e.g., ethyl cellulose, hydroxypropyl methyl cellulose, hydroxyethyl cellulose, etc.), hydrophobically modified alkali swellable emulsions or hydrophobically modified ethoxylate urethanes, molecular rheology modifiers, polysaccharides (e.g., Wellan gum, xantham gum, etc.), galactomannans (e.g., guar gum, carob gum, etc.), and the like, or a mixture thereof. In one embodiment, the admixture may include a sulfonate. In another embodiment, the admixture may include a cellulose polymer derivative. In a further embodiment, the admixture may include a polysaccharide. In one embodiment, the admixture includes at least two, such as at least three, such as at least four components.

In general, the rheological admixture(s) may be present in the core in an amount of 0 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The rheological admixture(s) may be present in the core in an amount of 10 wt. % or less, such as 8 wt. % or less, such as 6 wt. % or less, such as 6 wt. % or less, such as 5 wt. % or less, such as 4 wt. % or less, such as 3 wt. % or less, such as 2.5 wt. % or less, such as 2 wt. % or less, such as 1.75 wt. % or less, such as 1.5 wt. % or less, such as 1 wt. % or less, such as 0.8 wt. % or less based on the weight of the core. In addition, it should be understood that the aforementioned weight percentages may also apply to the amount of the rheological admixture(s) based on the weight of the cement board. Further, it should be understood that the aforementioned weight percentages may also apply to the amount of the rheological admixture(s) based on the weight of the slurry when discussed in the context of the cement slurry in making the cement board. In addition, the aforementioned percentages may also apply to a particular species within the rheological admixture.

The cement core may also include a surfactant. For instance, the surfactant may include those as generally known in the art. In general, the surfactant may have a hydrophilic-lipophilic balance (HLB) value of 5 or more, such as 8 or more, such as 10 or more, such as 12 or more, such as 15 or more, such as 18 or more. The HLB value may be 25 or less, such as 20 or less, such as 18 or less, such as 15 or less, such as 13 or less, such as 10 or less.

The surfactant may include a nonionic surfactant, an anionic surfactant, a cationic surfactant, or a mixture thereof. In one embodiment, the surfactant may include at least an anionic surfactant. In another embodiment, the surfactant may include at least a nonionic surfactant. In a further embodiment, the surfactant may include at least a cationic surfactant. In one particular embodiment, the surfactant may include a combination of an anionic surfactant and a nonionic surfactant.

As indicated above, in one embodiment, the surfactant may include an anionic surfactant. In general, anionic surfactants include those having one or more negatively charged functional groups. For instance, the anionic surfactant includes alkali metal or ammonium salts of alkyl, aryl or alkylaryl sulfonates, sulfates, phosphates. For instance, the anionic surfactant may include sodium lauryl sulfate, sodium octylphenol glycolether sulfate, sodium dodecylbenzene sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates.

In one particular embodiment, the anionic surfactant includes a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof.

As indicated above, in one embodiment, the surfactant may include a non-ionic surfactant. The non-ionic surfactant may be generally as known in the art. Generally, nonionic surfactants include, but are not limited to, amine oxides, fatty acid amides, ethoxylates (e.g., ethoxylated fatty acids, ethoxylated fatty alcohols, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics).

As indicated above, in one embodiment, the surfactant may include a cationic surfactant. Examples of the cationic surfactant may include water-soluble quaternary ammonium compounds, polyammonium salts, a polyoxyethylene alkylamine and the like.

In general, the surfactant(s) may be present in the core in an amount of 0 wt. % or more, such as 0.0001 wt. % or more, such as 0.0005 wt. % or more, such as 0.001 wt. % or more, such as 0.005 wt. % or more, such as 0.01 wt. % or more, such as 0.05 wt. % or more, such as 0.1 wt. % or more based on the weight of the core. The surfactant(s) may be present in the core in an amount of 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.15 wt. % or less, such as 0.1 wt. % or less, such as 0.08 wt. % or less, such as 0.05 wt. % or less, such as 0.03 wt. % or less, such as 0.01 wt. % or less, such as 0.005 wt. % or less, such as 0.001 wt. % or less based on the weight of the core. In one embodiment, a surfactant may not be utilized such that the weight percentage is 0. In addition, it should be understood that the aforementioned weight percentages may also apply to the amount of the surfactant(s) based on the weight of the cement board. Further, it should be understood that the aforementioned weight percentages may also apply to the amount of the surfactant(s) based on the weight of the slurry when discussed in the context of the cement slurry in making the cement board.

The cement core or slurry may also include a lime (calcium oxide). The lime may be a hydrated lime, a quick lime, or a mixture thereof. In this regard, such may convert to calcium hydroxide. The lime may be present in the core in an amount of 0 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The lime may be present in the core in an amount of 10 wt. % or less, such as 8 wt. % or less, such as 6 wt. % or less, such as 6 wt. % or less, such as 5 wt. % or less, such as 4 wt. % or less, such as 3 wt. % or less, such as 2.5 wt. % or less, such as 2 wt. % or less, such as 1.75 wt. % or less, such as 1.5 wt. % or less, such as 1 wt. % or less, such as 0.8 wt. % or less based on the weight of the core. In addition, it should be understood that the aforementioned weight percentages may also apply to the amount of the lime based on the weight of the cement board. Further, it should be understood that the aforementioned weight percentages may also apply to the amount of the lime based on the weight of the slurry when discussed in the context of the cement slurry in making the cement board. In addition, the aforementioned percentages may also apply to the calcium hydroxide formed from conversion of the calcium oxide.

The slurry utilized in making the cement board also includes water. Water may be employed for fluidity and also for hydration of the binders to allow for setting. The amount of water utilized is not necessarily limited by the present invention.

The water may be present in the slurry in an amount of 1 wt. % or more, such as 3 wt. % or more, such as 5 wt. % or more, such as 7 wt. % or more, such as 9 wt. % or more, such as 10 wt. % or more, such as 13 wt. % or more, such as 15 wt. % or more based on the weight of the slurry. The water may be present in the slurry in an amount of 40 wt. % or less, such as 30 wt. % or less, such as 25 wt. % or less, such as 20 wt. % or less, such as 15 wt. % or less, such as 10 wt. % or less based on the weight of the slurry.

For instance, the weight ratio of the water to the binders in the slurry may be 0.001 or more, such as 0.01 or more, such as 0.05 or more, such as 0.1 or more, such as 0.13 or more, such as 0.15 or more, such as 0.17 or more, such as 0.2 or more, such as 0.3 or more, such as 0.5 or more. The weight ratio of the water to the binders in the slurry may be 2 or less, such as 1.5 or less, such as 1.3 or less, such as 1 or less, such as 0.8 or less, such as 0.6 or less, such as 0.5 or less, such as 0.4 or less, such as 0.3 or less, such as 0.25 or less, such as 0.2 or less, such as 0.15 or less.

In addition, the slurry may have a particular pH. For instance, the slurry may be basic or alkaline. In this regard, the pH may be more than 7, such as 8 or more, such as 9 or more, such as 10 or more, such as11 or more, such as 11.5 or more, such as 12 or more, such as 12.5 or more. The pH may be 14 or less, such as 13.5 or less, such as 13 or less.

In addition to the binders and water as well as other additives/components mentioned above, the slurry may also include any other conventional additives as known in the art. Accordingly, these conventional additives may also be present in the core and board. In this regard, such additives are not necessarily limited by the present invention. For instance, the additives may include dispersants, foam or foaming agents (e.g., ethoxylated alcohols; sulfonates such as alpha olefin sulfonates; etc.), biocides (such as bactericides and/or fungicides), adhesives, pH adjusters, leveling agents, non-leveling agents, starches (such as pregelatinized starch, non-pregelatinized starch, and/or an acid modified starch), natural or synthetic polymers, colorants, fillers, fire retardants, reinforcements (e.g., fibers, such as glass fibers), etc.

In general, it should be understood that the types and amounts of such additives are not necessarily limited by the present invention. When present, each additive may be present in the slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the core The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the core. In addition, it should be understood that the aforementioned weight percentages may also apply to the amount of the additive(s) based on the weight of the cement board. Further, it should be understood that the aforementioned weight percentages may also apply to the amount of the additive(s) based on the weight of the slurry when discussed in the context of the cement slurry in making the cement board.

With respect to the additives above, it should be understood that any one of such additives may not be present in the cement board, cement core, or slurry. In this regard, the wt. % may be 0 wt. %. In other embodiments, the cement board, cement core, or slurry may be substantially free of such additive. For instance, it may be present in an amount of 0.1 wt. % or less, such as 0.08 wt. % or less, such as 0.05 wt. % or less, such as 0.04 wt. % or less, such as 0.03 wt. % or less, such as 0.02 wt. % or less, such as 0.01 wt. % or less, such as 0.005 wt. % or less. Such aforementioned weight percentages may be based on the weight of the core. In addition, it should be understood that the aforementioned weight percentages may also apply to the amount of the additive(s) based on the weight of the cement board. Further, it should be understood that the aforementioned weight percentages may be based on the weight of the slurry when discussed in the context of the cement slurry in making the cement board.

For example, in one embodiment, the cement core (as well as the slurry used to make the cement core) may not include or may be substantially free of fibers, such as glass and/or synthetic fibers. In one embodiment, the cement core (as well as the slurry used to make the cement core) may not include or may be substantially free of slate, such as expanded slate. In a further embodiment, the cement core (as well as the slurry used to make the cement core) may not include or may be substantially free of a rheology modifier, such as a clay and/or a cellulose ether. In a further embodiment, the cement core (as well as the slurry used to make the cement core) may not include or may be substantially free of shale, such as expanded shale. In another further embodiment, the cement core (as well as the slurry used to make the cement core) may not include or may be substantially free of clay, such as expanded clay. In an even further embodiment, the cement core (as well as the slurry used to make the cement core) may not include or may be substantially free of perlite, such as expanded perlite.

In general, the core has a first surface and a second surface opposite the first surface. The cement board may also include a facing material, for example on a surface thereof. In this regard, the cement board may include any facing material as generally known in the art. In one embodiment, the facing material may be disposed directly on the surface. Also, in one embodiment, the facing material may be provided with an adhesive between the facing material and the core. In one embodiment, the facing material may be provided such that it is embedded at least to a certain degree within the core. Accordingly, for embedding the facing material, it may have openings sufficiently large to permit penetration of the slurry into and through the openings, which can permit bonding (e.g., mechanical bonding) of the facing material to the core. The facing material may be embedded at a depth such that it is not visible. However, the pattern it creates on a surface may be slightly visible. For instance, the facing material may be embedded at a depth of about 0.1 mm or more, such as 0.2 mm or more, such as 0.3 mm or more, such as 0.4 mm or more, such as 0.5 mm or more, such as 0.8 mm or more, such as 1 mm or more. The depth may be 5 mm or less, such as 4 mm or less, such as 3 mm or less, such as 2 mm or less, such as 1.5 mm or less, such as 1.3 mm or less, such as 1 mm or less, such as 0.8 mm or less, such as 0.6 mm or less, such as 0.5 mm or less, such as 0.4 mm or less. The facing material may be embedded by applying friction, vibration, or a combination of both, to the slurry such that it can assist in the creation of a strong bond between the facing material and the slurry.

The facing material as described herein may be any facing material as generally employed in the art. For instance, the facing material may be a paper or cellulosic facing material, a fibrous (e.g., glass fiber) mat facing material, a mesh facing material, a polymeric facing material, or a combination thereof. In one embodiment, the facing material is a mesh facing material. For instance, the mesh facing material may be a glass mesh facing material. In addition, the mesh facing material may be coated.

It should be understood that the facing materials employed in the cement board may be all of the same type of material. Alternatively, it should also be understood that the facing materials employed in the cement board may be of different types of materials.

In one embodiment, the facing material may be coated, using various materials as generally known in the art. In addition, such materials may also be considered combustible. Yet, even with their inclusion in the cement board as described herein, the cement board may nonetheless be rendered non-combustible in accordance with the tests as defined herein. The coating may include a polymer, such as a thermoplastic polymer. The polymer may include polyvinyl chloride, polyvinylidene chloride, etc. as well as copolymers thereof. However, it should be understood that other polymers may also be used for the coating.

The thickness of the facing material is not necessarily limited. For instance, the facing material may have a thickness of 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The facing material may have a thickness of 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

The present invention is also directed to a method of making a cement board. The method may include a step of combining water and at least one binder. The method may also include combining any of the other aforementioned additives to form the slurry.

The manner in which the additives are combined is not necessarily limited. For instance, the slurry can be made using any method or device generally known in the art. In particular, the components of the slurry can be mixed or combined using any method or device generally known in the art. For instance, the components of the slurry may be combined in any type of device, such as a mixer and in particular a pin or paddle mixer. In addition, the device, such as the mixer, may operate as a batch process or as a continuous process.

As indicated above, the facing material may be provided on either or both sides of the core. In this regard, in one embodiment, the facing material may be provided prior to deposition of the slurry. For instance, the method may include a step of depositing the slurry onto a facing material. For instance, the facing material may be conveyed on a conveyor system (i.e., a continuous system for continuous manufacture of cement board). In this regard, the slurry may be directly deposited onto the facing material. Next, after depositing the slurry, a facing material may be provided on top of the slurry such that the slurry is sandwiched between the facing materials in order to form the cement board. When the facing materials are provided, they may be provided in such a manner as to provide a reinforced edge. For example, they may be provided such that the facing material covering one surface of the cement core wraps around a side edge so as to at least partially, and in one embodiment not completely, cover the facing material on the opposite side of the core. Without intending to be limited by theory, such wrap-around may augment the strength of the cement board at the border edge regions thereby allowing the board to retain sufficient structural integrity when a fastener, such as a screw or nail, is installed near the edge.

In addition or alternatively, edge strips may be utilized as disclosed at least in U.S. Pat. No. 9,499,980, which is hereby incorporated by reference in its entirety. For instance, edge strips may generally have a U-shaped configuration and adhere to respective marginal areas. The edge strips may be adhered to the longitudinal edge face, merely abut the longitudinal edge face or be spaced apart from the longitudinal face. The edge strip may, for example take on a U-shaped configuration as discussed herein. Alternatively, if desired, the longitudinal edge face or a part thereof may be open (i.e., not covered by an edge strip). In this latter case, one or both of the marginal areas adjacent a longitudinal edge on opposite broad or major faces may be provided with an edge reinforcing member.

The edge strips may be made of the same material as the facing materials disclosed therein. In one embodiment, the edge strips may be woven. For instance, the edge strips may be a mesh. In another embodiment, the edge strips may be non-woven. For instance, the edge strips may be a mat. The edge strips may be coated, such as using the coating materials mentioned herein with respect to the facing material. Regardless, examples of materials may include glass, steel, polyester, aramid resin, polyolefin, nylon fibers, polyvinylidene fluoride, polytetrafluoroethylene, cellulosics, and the like. In one particular embodiment, the material may be a polyester or a polyolefin. For example, the material may be a polyester (e.g., poly(ethylene terephthalate)). Alternatively, the material may be a polyolefin (e.g., polyethylene, polypropylene, etc.). Regardless, the edge strips may be made of a material allowing for relatively tight interstices such that it is generally impervious to the slurry.

The edge strips may be applied and bonded in any manner utilized in the art. For example, the edge strips may be applied utilizing an adhesive. Alternatively, the edge strips may be applied without utilizing an adhesive. For instance, the edge strips may simply adhere due to the cohesion between the slurry/core and the strips. In one embodiment, the edge strips may be applied such that they are on the exterior of the cement board. For example, they may be placed on the cement board after providing the facing materials.

Regardless of the configuration, after deposition of the slurry, the binder(s) reacts with the water to convert or set the binder(s). Such reaction may allow for the cement to set and become firm thereby allowing for the continuous sheet to be cut into cement boards at the desired length. In this regard, the method may comprise a step of reacting the binder(s) with water or allowing the binder(s) to convert or hydrate. In this regard, the method may allow for the slurry to set to form a continuous cement board sheet or a cement board.

The method may comprise a step of supplying the cement board or continuous cement board sheet to a heating device. For instance, such a heating device may be a kiln, an oven, or an autoclave and may allow for accelerating the hydration chemical reaction and or removal of any free water. The temperature and time required for heating in such a heating device are not necessarily limited by the present invention. Alternatively, the cement board may not enter into a heating device. Instead, the cement board may be allowed to undergo hydration/curing without requiring a heating device.

The method may also comprise a step of cutting a continuous cement board sheet into a cement board. In general, this may be conducted before or after exposing or providing the cement board or continuous cement board sheet to a heating device. For instance, in one embodiment, after the cutting step, the method may comprise a step of supplying the cement board to a heating device. In another embodiment, the method may comprise a step of cutting a continuous cement board sheet into a cement board after the heating step. In a further embodiment wherein a heating device is not utilized, the method may simply comprise a step of cutting a continuous cement board sheet into a cement board.

While the above generally discloses a method for making a cement board, it should be understood that such general method is disclosed in the art. For instance, general methods are disclosed at least in U.S. Pat. No. 9,499,980, which is hereby incorporated by reference in its entirety.

The thickness of the cement board, and in particular, the core, is not necessarily limited and may be from about 0.25 inches to about 1 inch. For instance, the thickness may be at least ¼ inches, such as at least 5/16 inches, such as at least ⅜ inches, such as at least 7/16 inches, such as at least ½ inches, such as at least ⅝ inches, such as at least ¾ inches, such as at least 1 inch, such as at least 1.5 inches, such as at least 2 inches. In this regard, the thickness may be about any one of the aforementioned values. For instance, the thickness may be about ¼ inches. Alternatively, the thickness may be about ⅜ inches. In one embodiment, the thickness may be about 7/16 inches. In another embodiment, the thickness may be about ½ inches. In a further embodiment, the thickness may be about ⅝ inches. In another embodiment, the thickness may be about ¾ inches. In another further embodiment, thickness may be about 1 inch. With regard to the thickness, the term “about” may be defined as within 5%, such as within 4%, such as within 3%, such as within 2%, such as within 1%.

In addition, the weight of the cement board is not necessarily limited. For instance, the cement board may have a weight of 0.5 lbs/ft2 or more, such as 1 lb/ft2 or more, such as 1.3 lbs/ft2 or more, such as 1.5 lbs/ft2 or more, such as 1.8 lbs/ft2 or more, such as 2 lbs/ft2 or more, such as 2.3 lbs/ft2 or more, such as 2.5 lbs/ft2 or more, such as 2.8 lbs/ft2 or more, such as 3 lbs/ft2 or more, such as 3.3 lbs/ft2 or more, such as 3.5 lbs/ft2 or more, such as 3.8 lbs/ft2 or more, such as 4 lbs/ft2 or more. The weight may be 7 lbs/ft2, such as 6 lbs/ft2 or less, such as 5.5 lbs/ft2 or less, such as 5 lbs/ft2 or less, such as 4.8 lbs/ft2 or less, such as 4.5 lbs/ft2 or less, such as 4.3 lbs/ft2 or less, such as 4 lbs/ft2 or less, such as 3.8 lbs/ft2 or less, such as 3.5 lbs/ft2 or less, such as 3.3 lbs/ft2 or less, such as 3 lbs/ft2 or less, such as 2.8 lbs/ft2 or less, such as 2.5 lbs/ft2 or less. Such weight may be a dry weight such as after the board leaves the heating device (e.g., kiln).

In addition, the density of the cement board is not necessarily limited. For instance, the cement board may have a density of 30 lbs/ft3 or more, such as 35 lbs/ft3 or more, such as 40 lbs/ft3 or more, such as 45 lbs/ft3 or more, such as 50 lbs/ft3 or more, such as 55 lbs/ft3 or more, such as 60 lbs/ft3 or more, such as 65 lbs/ft3 or more. The density may be 150 lbs/ft3 or less, such as 140 lbs/ft3 or less, such as 130 lbs/ft3 or less, such as 120 lbs/ft3 or less, such as 110 lbs/ft3 or less, such as 100 lbs/ft3 or less, such as 90 lbs/ft3 or less, such as 80 lbs/ft3 or less, such as 75 lbs/ft3 or less, such as 70 lbs/ft3 or less, such as 65 lbs/ft3 or less, such as 60 lbs/ft3 or less.

The cement board may have a certain fastener holding, which generally is a measure of the force required to pull a cement board off a wall by forcing a fastener head through the board. The values obtained from the fastener pull test generally indicate the maximum stress achieved while the fastener head penetrates through the board surface and core. In this regard, the cement board exhibits a fastener holding of at least about 30 lbf, such as at least about 40 lbf, such as at least about 50 lbf, such as at least about 60 lbf, such as at least about 70 lbf, such as at least about 80 lbf, such as at least about 85 lbf, such as at least about 90 lbf, such as at least about 95 lbf, such as at least about 100 lbf, such as at least about 110 lbf, such as at least about 120 lbf, such as at least about 130 lbf, as tested according to ASTM C₄₇₃ or ASTM D1037. The fastener holding may be about 200 lbf or less, such as 180 lbf or less, such as about 150 lbf or less, such as about 140 lbf or less, such as about 130 lbf or less, such as about 120 lbf or less, such as about 110 lbf or less, such as about 105 lbf or less, such as about 100 lbf or less, such as about 95 lbf or less, such as about 90 lbf or less. Such fastener holding may be based upon the thickness and/or density of the cement board and/or the type of facing material and correspoding cohesive strength with the board's core. For instance, when conducting a test, such fastener holding values may vary depending on the thickness of the cement board. As an example, the fastener holding values above may be for a ⅝ inch cement board. However, it should be understood that instead of a ⅝ inch cement board, such fastener holding values may be for any other thickness cement board as mentioned herein. For instance, such fastener holding values may be for a ¼ inch cement board, a ½ cement board, a ¾ inch cement board, a 1 inch cement board, etc. In addition, such fastener holding values may be for a wet condition. Alternatively, such values may be for a dry condition. Further, such values may apply to both a wet and dry condition.

The cement board may have a certain compressive strength. For instance, the compressive strength may be about such as about 250 psi or more, such as about 500 psi or more, such as about 700 psi or more, such as about 900 psi or more, such as about 1,000 psi or more, such as about 1,100 psi or more, such as about 1,200 psi or more, such as about 1,250 psi or more, such as about 1,300 psi or more, such as about 1,500 psi or more as tested according to ASTM D2394. The compressive strength may be about 5,000 psi or less, such as about 4,000 psi or less, such as about 3,000 psi or less, such as about 2,500 psi or less, such as about 2,000 psi or less, such as about 1,800 psi or less, such as about 1,700 psi or less, such as about 1,600 psi or less, such as about 1,500 psi or less, such as about 1,400 psi or less, such as about 1,300 psi or less, such as about 1,250 psi or less. Such compressive strength may be based upon the thickness and/or density of the cement board. For instance, when conducting a test, such compressive strength values may vary depending on the thickness and/or density of the cement board. As an example, the compressive strength values above may be for a ⅝ inch cement board. However, it should be understood that instead of a ⅝ inch cement board, such compressive strength values may be for any other thickness cement board as mentioned herein. For instance, such compressive strength values may be for a ¼ inch cement board, a ½ cement board, a ¾ inch cement board, a 1 inch cement board, etc.

The cement board may have a certain flexural strength. For instance, the flexural strength may be about such as about 250 psi or more, such as about 350 psi or more, such as about 400 psi or more, such as about 500 psi or more, such as about 600 psi or more, such as about 700 psi or more, such as about 750 psi or more, such as about 800 psi or more, such as about 1,000 psi or more as tested according to ASTM C₉₄₇ which is prescribed by ASTM C₁₃₂₅. The flexural strength may be about 3,000 psi or less, such as about 2,500 psi or less, such as about 2,000 psi or less, 1,700 psi or less, such as about 1,500 psi or less, such as about 1,300 psi or less, such as about 1,100 psi or less, such as about 1,000 psi or less, such as about 900 psi or less, such as about 800 psi or less, such as about 750 psi or less, such as 650 psi or less. Such flexural strength may be based upon the thickness of the cement board, core density and/or reinforcement tensile strength. For instance, when conducting a test, such flexural strength values may vary depending on the thickness of the cement board. As an example, the flexural strength values above may be for a ⅝ inch cement board. However, it should be understood that instead of a ⅝ inch cement board, such flexural strength values may be for any other thickness cement board as mentioned herein. For instance, such flexural strength values may be for a ¼ inch cement board, a ½ cement board, a ¾ inch cement board, a 1 inch cement board, etc.

The cement board disclosed herein may have many applications. For instance, the cement board may be utilized for interior or exterior applications. The cement board may be used as a standalone board in construction for the preparation of walls, ceilings, floors, etc. In addition, it may be utilized in an environment that may generally be humid or wet, such as shower rooms, bathrooms, lock rooms, etc. In addition, it may be utilized in an area requiring high impact resistance and/or resistance to freezing and thawing. For example, it may be utilized as a substrate for a stucco wall system or a masonry veneer wall system. Once the panel is affixed, as desired or necessary, another material may be affixed thereto such as, for example, ceramic tile, brick, marble panels, stucco, or the like. Reinforced cementitious panels or boards having cores formed of a cementitious composition with a surface being reinforced is demonstrated in U.S. Pat. Nos. 1,439,954, 3,284,980, 4,450,022, and 4,916,004, which are hereby incorporated by reference in their entirety. In addition, cement boards with reinforced edges are disclosed in U.S. Pat. No. 6,187,409, which is hereby incorporated by reference in its entirety.

### EXAMPLES

Test Methods

CAN/ULC-S114:2018: The non-combustibility test is conducted in accordance with CAN/ULC-S114:2018. The apparatus and furnace are utilized as disclosed therein. The specimens shall be 38 mm wide by 38 mm thick in a cross-section perpendicular to the axis of the furnace and 50 mm long. The tolerance in each dimension shall be ±2 mm. Specimens shall be dried to 60±3° C. for not less than 24 hours nor more than 48 hours and allowed to cool to room temperature in a dry atmosphere before being tested. In addition, at least three specimens of the sample shall be tested and average values shall be used for determining the maximum temperature rise. The mass of the specimen shall be determined before and after the test.

In carrying out the test, the furnace shall first be heated to a temperature of 750±3° C. at the controlling thermocouple T2 and be stabilized at that temperature to within ±1° C. through a 15 minute period. Thereafter, the specimen shall then be placed in the sample holder, with its long axis vertical, and inserted in the furnace. For this operation, the bottom plug of the furnace shall be temporarily removed and the basket holding the specimen mounted on its ceramic support. No longer than 10 seconds shall elapse between the opening and closing of the furnace. The test shall be continued for a period of 15 minutes or less if it is clearly evident that the specimen does not pass the test. The current through the heating coils shall not be adjusted during the test. Throughout the test run, temperatures at the indicating thermocouple T1, shall be recorded at maximum intervals of 5 seconds. Visual observations on the specimen shall also be made and recorded, noting intensity and duration of smoking, time of flaming and change of state.

### Example 1

A cement board was prepared using sand, Portland cement, fly ash, limestone, calcium aluminate cement, expanded polystyrene beads, silicone treated perlite, and water. The weight percentages of these components as present in the cement slurry used in making the cement core and corresponding cement board are provided below:

| Component | Wt. % Based on Cement Slurry |
|---|---|
| Sand | 39.0 |
| Portland cement | 37.0 |
| Fly ash | 0 |
| Water | 13.6 |
| Limestone | 1.9 |
| Calcium aluminate cement | 3.6 |
| Expanded polystyrene beads | 0.4 |
| Silicone treated perlite | 2.3 |
| Other additives | 2.2 |

### Example 2

A cement board was prepared using Portland cement, limestone, calcium aluminate cement, expanded polystyrene beads, lime, cellulose ether, expanded shale. The total parts and weight percentages of these components as present in the cement slurry used in making the cement core and corresponding cement board are provided below:

| Component (percentage) | A1 | A2 | B1 | B2 |
|---|---|---|---|---|
| Portland cement | 26.34 | 26.34 | 26.60 | 26.60 |
| Calcium aluminate | 4.74 | 4.74 | 4.78 | 4.78 |
| cement | | | | |
| Limestone | 6.63 | 6.63 | 11.48 | 11.48 |
| Hydrated lime | 0.84 | 0.84 | 0.85 | 0.85 |
| Expanded shale | 44.54 | 44.54 | 39.22 | 39.22 |
| Expanded | 0.38 | 0.38 | 0.38 | 0.38 |
| polystyrene beads | | | | |
| Water | 15.97 | 16.11 | 16.13 | 16.11 |
| Other additives | approx. | approx. | approx. | approx. |
| | 0.55 | 0.58 | 0.56 | 0.58 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1-36. (canceled)

38. A cement board, comprising:
a cement core having a first surface and a second surface opposite the first surface, the cement core comprising a binder comprising a cement, a lightweight aggregate, and a combustible additive, wherein the combustible additive is present in an amount of greater than 0 wt. % to less than 0.5 wt. % based on the weight of the cement core,
wherein the cement board passes CAN/ULC-S114:2018.

39. The cement board of claim 38, wherein the cement comprises Portland cement, magnesia cement, alumina cement, calcium sulphoaluminate cement, or a mixture thereof.

40. The cement board of claim 38, wherein the binder further comprises a pozzolan material.

41. The cement board of claim 40, wherein the pozzolan material comprises blast furnace slag, metakaolin, silica fume, microsilica, lime, or a mixture thereof.

42. The cement board of claim 38, wherein the cement board comprises 10 wt. % or less of fly ash.

43. The cement board of claim 38, wherein the cement board comprises 1 wt. % or less of fly ash.

44. The cement board of claim 38, wherein the combustible additive comprises expanded polystyrene.

45. The cement board of claim 38, wherein the combustible additive is present in an amount of 0.45 wt. % or less based on the weight of the cement core.

46. The cement board of claim 38, wherein the combustible additive is present in an amount of 0.4 wt. % or less based on the weight of the cement core.

47. The cement board of claim 38, wherein the lightweight aggregate is present in an amount of from 0.1 wt. % to 50 wt. % based on the weight of the cement core.

48. The cement board of claim 38, wherein the lightweight aggregate comprises expanded clay, expanded vermiculite, expanded pumice, expanded glass, hollow spheres, or a mixture thereof.

49. The cement board of claim 38, wherein the lightweight aggregate comprises expanded perlite.

50. The cement board of claim 38, wherein the lightweight aggregate comprises expanded shale.

51. The cement board of claim 50, wherein the expanded shale has a density of 75 pcf or less to 30 pcf or more.

52. The cement board of claim 38, wherein the cement core further comprises a normal weight aggregate.

53. The cement board of claim 52, wherein the normal weight aggregate comprises sand, limestone, stone, shale, clay, granite, or a mixture thereof.

54. The cement board of claim 52, wherein the normal weight aggregate is present in an amount of from 0.1 wt. % to 80 wt. % based on the weight of the cement core.

55. The cement board of claim 38, wherein the cement board has a density of from 40 lbs/ft3 to 80 lbs/ft3.

56. The cement board of claim 38, wherein the cement board exhibits a compressive strength of about 1,700 psi or less.

57. The cement board of claim 38, wherein the mean of the maximum temperature under CAN/ULC-S114:2018 is 35° C. or less, there is no flaming under CAN/ULC-S114:2018 during the last 14.6 minutes of the test, and/or the maximum loss of weight under CAN/ULC-S114:2018 is 19 wt. % or less.

58. The cement board of claim 38, wherein the cement board also passes ASTM E136-19a.

59. The cement board of claim 38, wherein the cement board exhibits an average weight loss of 50% or less when tested in accordance with ASTM E136-19a and/or the surface temperature of the cement board does not rise more than 30° C. when tested in accordance with ASTM E136-19a.

60. A cement board, comprising:
a cement core having a first surface and a second surface opposite the first surface, the cement core comprising a binder, a lightweight aggregate, and a combustible additive, wherein the combustible additive is present in an amount of greater than 0 wt. % to less than 0.5 wt. % based on the weight of the cement core,
wherein the cement board passes ASTM E136-19a.
